(19) United States
(12) Patent Application Publication
(10) Pub. No.: US 2014/0258226 A1
(43) Pub. Date: Sep. 11, 2014

(54) ASYNCHRONOUS TRANSACTION MANAGEMENT, SYSTEMS AND METHODS

(71) Applicant: Southpaw Technology, Inc., Toronto (CA)

(72) Inventor: Remko Noteboom, Toronto (CA)

(73) Assignee: Southpaw Technology, Inc., Toronto (CA)

(21) Appl. No.: 14/204,158

(22) Filed: Mar. 11, 2014

Related U.S. Application Data
(60) Provisional application No. 61/776,503, filed on Mar. 11, 2013.

(51) Int. Cl. G06F 17/30

(52) U.S. Cl. CPC G06F 17/30227
USPC 707/615

(57) ABSTRACT

The invention discloses a system and method for simulating the asynchronous replication process. Transactions received by a server can be organized according to timestamp information or other metadata information, and are executed. The timestamp information can be modified to allow for time-shifted execution of the transactions, thereby compressing or extending the duration of the simulation.

This application claims priority to U.S. Provisional Application No. 61/776,503, filed Mar. 11, 2013. U.S. Provisional Application 61/776,503 and all other referenced extrinsic materials are incorporated herein by reference in their entirety.

### FIELD OF THE INVENTION

The field of the invention is database transaction technologies.

### BACKGROUND

The following description includes information that can be useful in understanding the present invention. It is not an admission that any of the information provided herein is prior art or relevant to the presently claimed invention, or that any publication specifically or implicitly referenced is prior art.

Data synchronization allows maintain data integrity of source data by accurately tracking the access of or changes to the data, and then updating the data to reflect any changes. This is a crucial aspect of collaborative work environments, where the distributed members of a work group must be able to rely on the data as being updated, accurate and consistent across the entire work group so that any changes made to the data as the work progresses do not conflict with one another. Synchronous data replication in a networked computing environment provides real-time data synchronization by effecting changes to the source data as soon as they are made. This allows changes to be processes in the chronological order that they are made, preserving data integrity. The disadvantage of the synchronous replication is that a constant connection is required between all of the members of the networked environment so that the changes can be communicated to all members as they occur.

Asynchronous replication eliminates the requirement of the constant connection required by synchronous replication. However, because asynchronous replication requires a gathering of transactions and then a replication of the transactions at the source data repository, there can be considerable delay in the application of the transactions to the source data. If a conflict exists, it is only discovered during the real-world time-based replication of the transactions.

Others have put for effort towards asynchronous transfers and replication of transactions between computing devices, and to simulate aspects of the replication process in an attempt to streamline or optimize the asynchronous replication process.

U.S. Pat. No. 7,376,675 B2 to Pruet, III (“Pruet”) titled “Simulating Multi-User Activity While Maintaining Original Linear Request Order for Asynchronous Transactional Events,” issued Can 20, 2008, discusses maintaining the original order of a sequence of transaction, and simulating multi-user processing of events while maintaining the original linear order. Pruet does not discuss simulating the asynchronous replication of transactions on a replication server, either synchronously with real-world time or in a time frame asynchronous from real-world time and either in the original order of the transactions or an order different from the original order.

U.S. Pat. No. 8,301,593 B2 to Hoffman, et al (“Hoffman”) titled “Mixed Mode Synchronous and Asynchronous Replication System,” issued Oct. 30, 2012, discusses a replication system capable of switching between synchronous and asynchronous replication modes, and simulating locks. Hoffman does not discuss simulating the asynchronous replication of transactions, where the order of the transactions can be rearranged and the simulated execution can be synchronous with real-world time or in a time frame asynchronous from real-world time.

U.S. Pat. No. 7,962,458 B2 to Holenstein, et al (“Holenstein”) titled “Method for Replicating Explicit Locks in a Data Replication Engine,” issued Jun. 14, 2011, discusses a locking protocol of a database environment where the locking operations can be performed asynchronously. Holenstein does not discuss simulating the asynchronous replication of transactions, where the order of the transactions can be rearranged and the simulated execution can be synchronous with real-world time or in a time frame asynchronous from real-world time.

U.S. published patent application 2012/0233123 A1 to Shisheng, et al (“Shisheng”), titled “System and Method for Providing Assured Recovery and Replication”, published Sep. 13, 2012, discusses simulating identical operations on both a master data source and a replica data source to ensure that the master data source and a replica data source are properly replicating for recovery and data loss prevention purposes. Shisheng does not discuss that operations can be performed in a different order or different time frame from the non-simulated operations.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention can contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

Thus, there is still a need for the asynchronous transaction replication in a time-efficient, user-desired manner, capable of detecting conflicts and optimizing the replication process.

### SUMMARY OF THE INVENTION

The inventive subject matter provides a system, apparatus or method capable of simulating asynchronous data replication. The apparatus, preferably an asynchronous replication server, has a non-transitory computer-readable memory (RAM, flash, ROM, hard drive, solid-state drive, etc.), at least one processor coupled with the memory, and a device interface configured to communicatively couple with other devices. The other devices can be, for example, other computing devices such as a client device or another server. The system can include one or more of the apparatus and other devices, each having one or more network connections to one or more of the other apparatus or other devices within the system. The method is a method of simulating asynchronous data replication, performed by the apparatus, or by the system including a computing device such as the apparatus and other devices.

The non-transitory computer-readable memory of the apparatus can store computer-readable instructions that, when executed by the processor, cause the apparatus to perform the steps of the invention.

The apparatus can be configured to receive at least one transaction message from a client device or another server. In some embodiments, the transaction message includes at least one transaction, and the transaction includes at least one instruction and transaction metadata. In some embodiments, the transaction metadata includes a transaction timestamp. In some embodiments, the transaction metadata can include one or more of geo-location information, priority value of the transaction, identification of a client, user or group, urgency, importance, conflict likelihood, risk, sensitivity level, confidentiality, type of transaction data, type of instruction, context, transaction latency, and transaction bandwidth.

In an embodiment, the apparatus is configured to generate an asynchronous transaction list, which comprises the transactions received by the apparatus in a given period of time.

The apparatus can be further configured to receive a transaction time for use as a reference point. The transaction time can be received according to a system clock or to an external global reference timekeeper.

The apparatus can be further configured to obtain an execution scheme.

The apparatus can be further configured to order the asynchronous transaction list as an ordered transaction list. The ordered transaction list can be the transaction organized as a function of the execution scheme and metadata.

In some embodiments, the execution scheme can be a linear or non-linear time scaling factor applied to the transaction timestamp of the transaction to determine the placement of the transaction within the ordered transaction list. In some embodiments, the execution scheme can be applied to one or more of geo-location information, priority value of the transaction, identification of a client, user or group, urgency, importance, conflict likelihood, risk, sensitivity level, confidentiality, type of transaction data, type of instruction, context, transaction latency, and transaction bandwidth to determine the placement of the transaction within the ordered transaction list.

The apparatus can further be configured to cause the execution of the ordered transaction list by a transaction engine.

In other embodiments, the apparatus can be configured to generate a simulation timeframe. The simulation time frame can be a representation of a span of real-world time. This real world-time span can include the points in time as indicated by the transaction timestamps of one or more transactions.

The apparatus can be further configured to generate one or more simulation timestamps within the simulation timeframe that correspond to the points in time indicated by the transaction timestamps within the real-world time span.

The apparatus can be further configured to map the simulation timestamps to the corresponding transactions and execute the transactions according to the simulation timestamps.

In some embodiments, the apparatus can be further configured to report an execution result. In some embodiments, the apparatus can be further configured to detect a conflict related to the execution of one or more transactions and report the conflict to a user.

In some embodiments, the apparatus can be further configured to generate a secondary simulation timestamp that corresponds to a second point in time within the real-world time span that is different from the point in time indicated by the transaction timestamp of a transaction and map and execute the transactions according to this secondary simulation timestamp.

In some embodiments, the secondary simulation time stamp can be generated as a function of one or more of geo-location information, priority value of the transaction, identification of a client, user or group, urgency, importance, conflict likelihood, risk, sensitivity level, confidentiality, type of transaction data, type of instruction, context, transaction latency, and transaction bandwidth.

An example of a system that can be adapted to execute the invention is the TACTIC™ asset management system by Southpaw Technology of Toronto, Canada. <provide reference>

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 provides an overview of the system of the invention

FIG. 2 presents a diagram of the transaction message and its contents.

FIG. 3 illustrates a flow diagram of the method of carrying out the invention according to an embodiment of the invention.

FIG. 4A-4B illustrates examples of transactions reorganized according to the implementation of various execution schemes.

FIG. 5 illustrates a flow diagram of the method of carrying out the invention according to another embodiment of the invention.

### DETAILED DESCRIPTION

Throughout the following discussion, numerous references will be made regarding servers, services, interfaces, portals, engines, modules, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should appreciate that the disclosed techniques provide many advantageous technical effects including time-shifted or time-independent simulation of an asynchronous replication process. For example, the simulation can be run at an increased speed to reduce the time required to run the simulation or run in reverse to undo the effects of executed transactions. Additional advantageous technical effects include generating one or more signals that cause devices to simulate or manage transactions, allowing for the prediction and resolution of conflicts and optimization by simulating different possible outcomes to the execution of the replication process.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

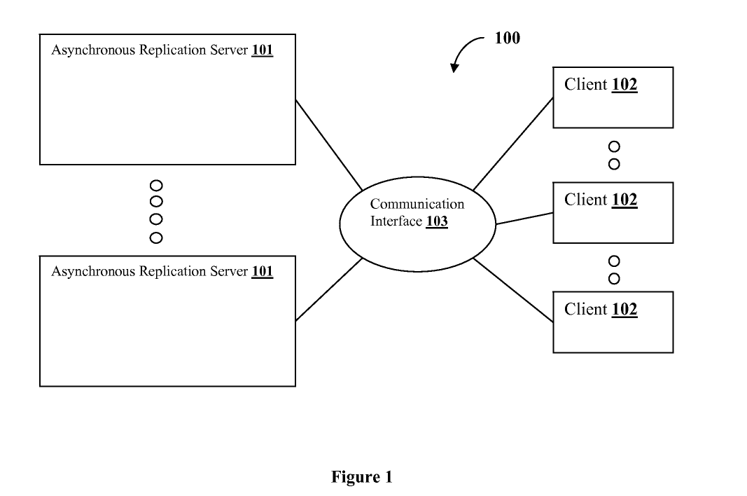

FIG. 1 provides a system overview according to an embodiment of the invention.

The database management system 100 of FIG. 1 includes an asynchronous replication server 101 connected to one or more clients 102 via communication interface 103. Communication interface 103 can be a network such as the internet, a cellular network or any other communication network enabling the exchange of data. The database management system 100 can also include any number of additional asynchronous replication servers 101, each of which can be connected to any or all of the asynchronous replication servers 101 and any or all of the clients 102 via communication interface 103.

The database management system 100 uses a set of foundation instructions upon which all higher level operations are built upon. This instructions set consists of the smallest atomic operations. Everything that the database management system 100 does to a set of data can be broken down to these instructions. At the lowest level of the architecture, all operations are automatically recorded in this fundamental instructions set. A group of these instructions can be packaged up into a transaction, which is treated as a higher level operation in which all instructions must either finish to completion or fail to a previous state.

These instructions can be run forwards or they can be run in reverse, which can constitute the equivalent of an Undo. In an asynchronous replication operation, the system can take these instructions and run them, possibly multiple times, on a server (e.g., an asynchronous replication server 101, etc.). In order to maintain consistency of data, the instructions can be run at the time they were run on the sending server or client device. This provides the opportunity to use conflict resolution between separate transactions that were run at different times. In other words, the transactions can be run asynchronously and still maintain data integrity.

Users at both the client and server levels can access the system via user interfaces. These interfaces can be web-based (accessible via an internet browser accessing an interface website or via a browser plug-in) or can be in the form of application programs running on the client and server devices themselves. The user interface allows users to manage, modify and execute the functions of the invention. The user interface can be tailored to the end user's role or position in an organization, to only allow access to data and functions that the users are authorized to access.

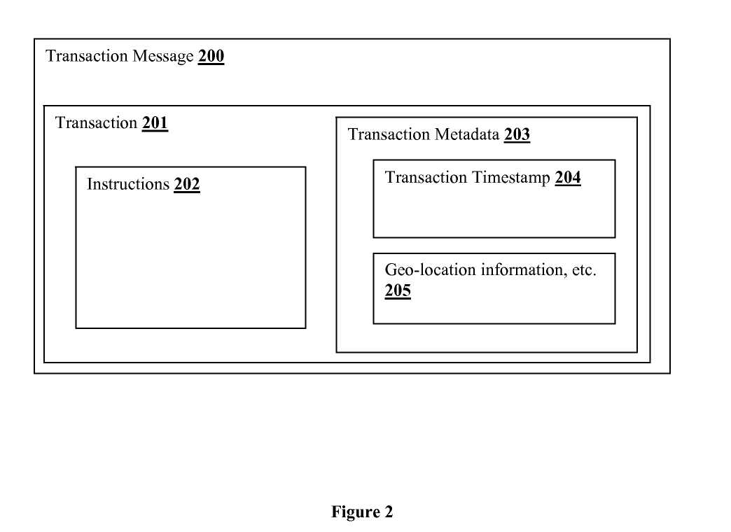

FIG. 2 depicts the transaction message 200 used by database management system 100. The transaction message 200 can comprise a transaction 201, which can include the transaction instructions 202 and transaction metadata 203.

The transaction metadata 203 includes information related to the original execution of the transaction on the client device, which can be used by the asynchronous transaction server 101 in the asynchronous replication process and simulation thereof. The transaction metadata 203 can include a transaction timestamp 204 that can represent or include one or more of a submission time (the time when the transaction was submitted), an acceptance time (the time when the transaction was accepted) and a commit time (the time when the transaction was committed). The transaction metadata 203 can include information such as geo-location information 205 of the client device where the transaction was executed or of the server carrying out the simulation or the replication. The transaction metadata 203 can also include other identifying information 205 for the transaction such as a priority value of the transaction, identification of a client, user or group, urgency, importance, conflict likelihood, risk, sensitivity level, confidentiality, type of transaction data, type of instruction, context, transaction latency, and transaction bandwidth.

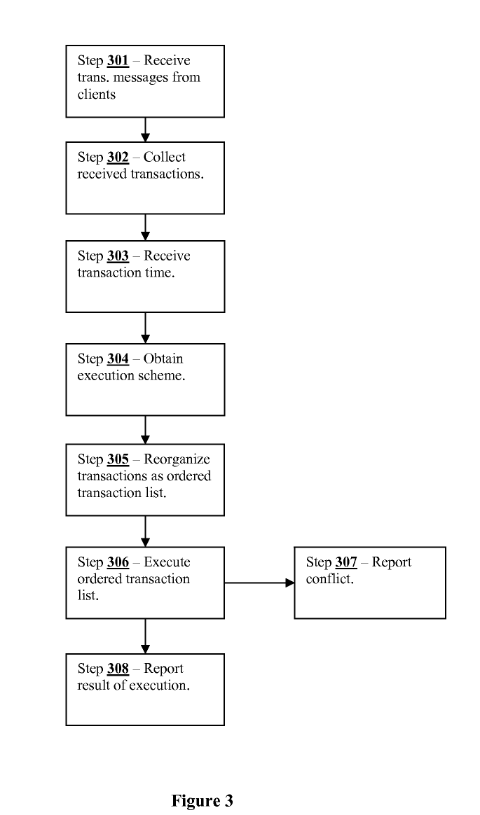

FIG. 3 depicts a method of simulating or modeling the asynchronous replication of one or more transactions 200 according to an embodiment of the invention.

At step 301, the asynchronous replication server 101 receives one or more transaction messages 200 from one or more of clients 102.

At step 302, the asynchronous replication server 101 collects all of the received transactions 201 (received in transaction messages 200) received within a particular range of time (e.g., all of the transactions received in the last hour, day, month, etc.) and generates an asynchronous transaction list. The asynchronous transaction list can be organized according to the timestamp information of the transaction, the order in which the transactions were received by

At step 303, the asynchronous replication server 101 receives a transaction time. The transaction time is a real-world time reference point for the execution of the simulation. For example, the transaction time can be a scheduled start time or end time for the simulation. The transaction time can be the time that the actual execution of the simulation is ordered by a user (e.g., the system time or global time when the user provides the simulation execution order at a user interface). The real-world time can be the system clock of the asynchronous replication server 101, an external clock used to reference real-world time (such as those used by the global positioning system), or any other time reference that is used in the actual (i.e. non-simulated) asynchronous replication process.

At step 304, the asynchronous replication server 101 obtains an execution scheme.

The execution scheme can be a value, set of rules and/or algorithm used, in combination with the transaction metadata, to reorganize the transactions within the asynchronous transaction list into the desired replication order in the form of an ordered transaction list. For example, the execution scheme can be an algorithm that can modify the timestamp of a transaction relative to the transaction time received at step 302 and/or relative to the time stamps of other transactions. Values can be used as inputs to the algorithm to determine the degree to which a transaction timestamp is modified. The execution scheme can also include prioritization algorithms that can execute matching and/or comparisons of various transaction metadata between the transactions, for the purposes of reorganizing the transaction order. The execution scheme is applied to one or more of the elements of the transaction metadata of each transaction to affect when the transactions are replicated during execution.

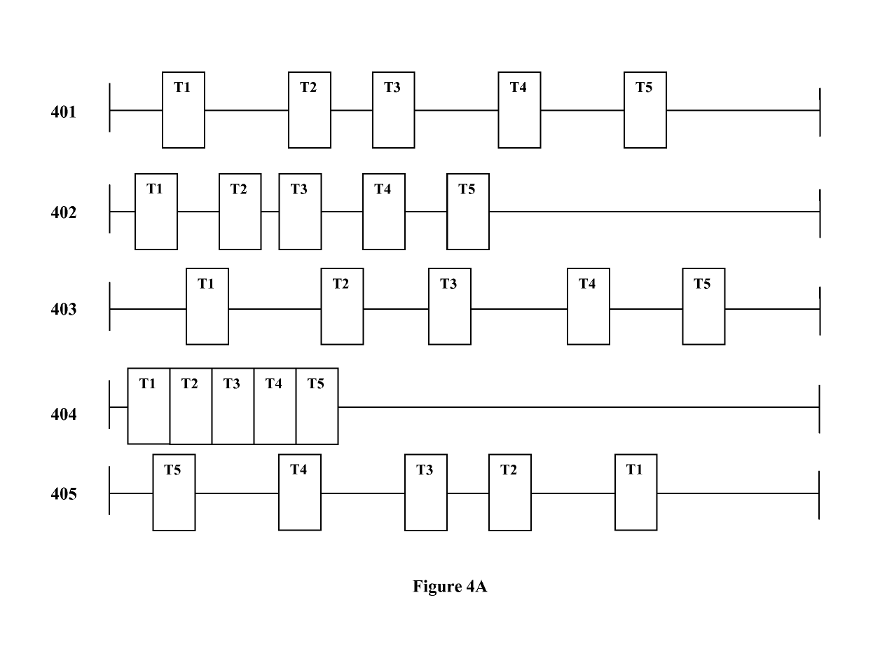

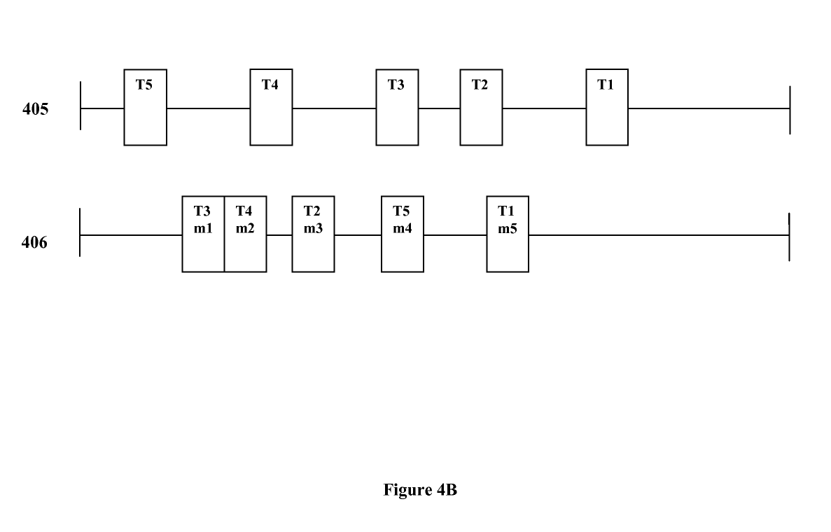

FIGS. 4A-4B provide illustrative examples 401-406 of transactions reorganized according to the implementation of execution schemes, according to embodiments of the inventive subject matter. In each example, the line represents a time line to illustrate the temporal and ordering effects of the implemented execution schemes. The time line can represent a real-world time frame, such as a period of time to execute all received transactions, or the range of time used by the asynchronous replication server to collect the received transactions at step 302. The examples of FIG. 4A-4B show five transactions T1-T5 arranged according to various execution schemes. Each of the transactions T1-T5 can be transactions such as the transaction 201 of FIG. 2, having transaction metadata including a transaction timestamp and additional metadata such as geo-location information and/or information from one or more of categories mentioned above. In the examples of FIG. 4A-4B, the labeling of transactions T1-T5 is reflective of the order in which the transactions were conducted chronologically on their respective clients, according to their timestamp information.

The execution scheme can be applied to the transaction timestamp of the transaction. As shown by example 401, the execution scheme can arrange the transactions T1-T5 in chronological order according to their respective timestamp information, where the execution of the ordered list is a mirror of the actual execution times of each transaction on the client side, including the time between each transaction. Thus, the time “gaps” between each transaction in example 401 corresponds to the real-world time duration between each transaction.

In embodiments, the execution scheme can be a time scaling factor that serves to modify the timestamp information when the timestamp information is used for the placement of the transaction within the ordered transaction list. For example, the time scaling factor can be used to place the transaction closer in real-world time to the transaction time as shown in example 402 (thus compressing the real-world time required to reach the execution the transaction within the ordered transaction list, or “fast-forward”) or farther in real-world time to the transaction time as shown in example 403 (expanding the time to reach the execution of the transaction, thus slowing down the execution of the ordered transaction list). As shown in example 404, the execution scheme can also remove the time periods between the real-world points of time indicated by the timestamps, resulting in the execution of the transactions within the ordered transaction list as soon as possible (i.e. the execution of the next transaction in the list is performed immediately following the conclusion of the previously executed transaction). The execution scheme can also arrange the transactions into reverse chronological order, allowing for “rewind” or “undo” operations, such as in example 405.

The execution scheme can also be applied to geo-location metadata or customized metadata (such as metadata indicating the priority or importance of the transaction) to affect the arrangement of ordered transaction list according to factors important to the user. The transactions of example 406 illustrate a result where the execution scheme applies metadata to the reorganization. In this example, the transactions are shown as arranged according to a “metadata order”, reflective of the order resulting from the execution scheme applied to the metadata m1-m5 (e.g., most ‘important’ geo-location data, or other prioritization metadata being used). In embodiments, the application of the execution scheme can be based on a prioritization of the transactions based on the desired aspects of metadata independent of the timestamps, such as by a strict ranking according to pre-set hierarchies of metadata categories and/or category values. In other embodiments, the metadata can be used as a weighting function or input value to an execution scheme that modifies the timestamping, such that ultimately the rearranging of the transactions is performed based on the transaction timestamps as influenced by the desired metadata factors.

The execution scheme can be linear or non-linear, allowing for the rearranging of each of the transactions within the asynchronous transaction list individually.

At step 305, the transactions of the asynchronous transaction list are reorganized according to the execution scheme and the transaction metadata as the ordered transaction list. As noted above, examples of the results of step 305 are illustrated in FIG. 4.

At step 306, the asynchronous replication server causes a transaction engine to execute the ordered transaction list. The transaction engine can be a software application within the same asynchronous replication server or another one of asynchronous replication servers that is executed by the server's processor to carry out the ordered transaction list. The transaction engine may, alternatively, be a separate hardware component within asynchronous replication server or another one of asynchronous replication servers programmed to execute the ordered transaction list. In an embodiment, the transaction engine can be a separate hardware device external to the asynchronous replication server programmed to execute the ordered transaction list.

If a conflict is detected during the execution of step 306, the conflict is reported to a user at step 307.

At step 308, the result of the execution of the ordered transaction list is reported to a user.

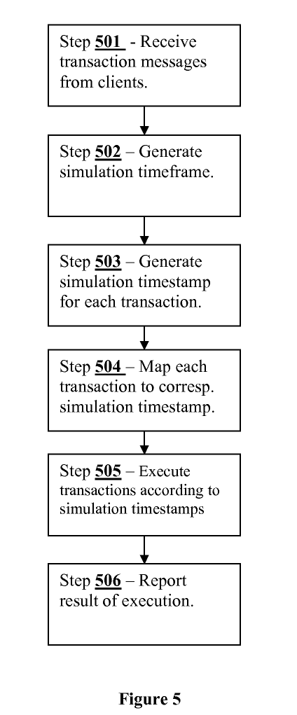

FIG. 5 depicts a method of simulating or modeling the asynchronous replication of one or more transactions according to an embodiment of the invention.

At step 501, the asynchronous replication server 101 receives one or more transaction messages from one or more of clients.

At step 502, the asynchronous replication server 101 generates a simulation timeframe. The simulation timeframe represents a real-world time span, and is also the duration of the simulation in real-world time. For example, the simulation time frame can represent a day of real-world time, but the duration of the simulation timeframe can only be an hour of real-world time.

At step 503, the asynchronous replication server 101 generates a simulation timestamp for each of the transactions. The relationship of the transaction timestamp to the real-world time span is directly proportional to the relationship of the simulation timestamp to the simulation timeframe. For example, provided a real-world time span to be simulated is a 24 hour period and the timestamp of a transaction indicates the 6th hour of the 24 hour period, in a simulation timeframe of one hour, the simulation timestamp would be placed at the 15 minute mark of the simulation timeframe.

At step 504, the asynchronous replication server 101 maps each transaction to the simulation timestamp corresponding to that transaction.

At step 505, the asynchronous replication server executes each of the transactions according to the timeframe indicated by the simulation timestamp corresponding to the respective transaction.

The simulation timeframe can be synchronous with the real-world time span (i.e., the simulation timeframe is a 1:1 model of the real-world time span it represents). The simulation timeframe can be asynchronous with the real-world time span (the duration of the simulation timeframe can be longer or shorter than the real-world time span it represents). The simulation timeframe can also be a reversal of the real-world time span (starting at the end of the real-world time span), allowing for “rewind” and “undo” operations.

The simulation timeframe can be an isochronous simulation time frame, where all of the transactions are evenly distributed within the simulation timeframe, the simulation timeframe having an equal time between the execution of each transaction.

If a conflict is detected during the execution of step 505, the conflict is reported to a user.

At step 506, the result of the execution of the transactions is reported to a user.

The method described by steps 501-506 result in the execution of the transactions in the chronological order of the transaction timestamps. However, it can be desirable for a user to simulate the execution of the transactions in an order other than in chronological order. To achieve this result, the simulation timestamp used in steps 501-506 is replaced by a secondary simulation timestamp.

Whereas the simulation timestamp corresponds to the point in time in the real-world time span indicated by the transaction timestamp (as described above), the secondary simulation timestamp corresponds to a point in time in real-world other than the point in time indicated by the transaction timestamp.

The secondary simulation timestamp can be generated as a function of the transaction metadata, where location of the secondary simulation timestamp within the simulation timeframe can be adjusted based on transaction metadata information. The transaction metadata information used to generate the secondary simulation timestamp can include information indicating a value or preference in categories including geo-location information, priority value of the transaction, identification of a client, user or group, urgency, importance, conflict likelihood, risk, sensitivity level, confidentiality, type of transaction data, type of instruction, context, transaction latency, and transaction bandwidth.

The database management system does not rely on a particular transport mechanism to transfer the transaction from one server to another, only that the transfer successfully occurs. This provides a layer of flexibility in that the transaction can be transferred in any number of ways using any number of sharing protocols, such as http, Dropbox™, rsync, email, Google drive, etc. The transaction can either be actively sent or broadcast from a client or it could be passively transmitted, where the receiving server retrieves the transaction from the client.

The transaction described in embodiments of the invention can be created using a proprietary protocol. Because the transaction could be written in the proprietary protocol, it is required that the database management system creates the transactions. At the most basic level, a transaction (i.e. the instructions that make up a transaction) can be created simply in a text editor if a user knows the protocol. By extension, any application can produce a valid transaction which can then be run on a server belonging to the database management system.

As stated above, the database management system has defined a set of foundation instructions upon which all higher level instructions are built upon. The current protocol includes almost all database operations and almost all file operations. As it becomes necessary to include other types of operations, they can be added to the foundation-level instruction set of the protocol.

A variety of data security measures can be employed to protect data from unauthorized access. These methods can be used alone or in combination, depending on the level of security desired:

In an embodiment, the transactions can be bundled up as packets of information. To provide data security, the packets can be encrypted and decrypted using a variety of agreed about encryption techniques. For example, using an asymmetrical encryption scheme involving a public and private key, only the receiving server would have the knowledge to decrypt the package.

In an embodiment, data security can be provided by breaking up a transaction into various packets and reassemble them at the other end. The transaction would only run when all the needed packets have arrived.

In an embodiment, data security can be provided by the database management system by filtering a transaction to only send out information that a particular server or servers are allowed to see. Each instruction within a transaction must go through security filters based on the rules attributed to groups which a user belongs. A particular group can not, for example, see particular piece of information due to security rules prohibiting it. This can also be applied to remote servers. So a particular transaction that is to be sent is always filtered the security rule at an instruction by instruction level. This ensures that the transaction is filtered before sending to the remote server according the rules associated with that server.

In an embodiment, the database management system could broadcast “garbage” or “noise” packets, of which only the receiving server would know how to filter the “garbage” packages from the “message” package, thereby obfuscating highly sensitive data.

Also, these packets can store a category key or “channel”. By filtering the related packets for certain keys or “channels” a receiving server could “tune” into a stream of transactions on a particular channel. The opens up the possibility of broadcasting transactions more openly and allowing these servers to “listen” to certain broadcasts.

The following are some examples of applications of the invention:

A Company has an overseas facility and they must work on the same project. They are separated by an internet connection that is not very reliable and suffers from high latency. They set up two asynchronous replication servers and each location works locally with their own server. The database management system transfers transactions asynchronously from one server to the other server and those transactions are rerun.

A company has five data centers. They work heavily on large files however each facility needs to know what the other has. Transactions occur locally, however only smaller versions of the files are sent to the remote servers in the transaction for immediate viewing. Larger files can either remain at the originating center or they can be sent asynchronously at a later period, depending on the needs of the project.

Two companies must work together but each have strong security needs. They each have their own asynchronous replication server and only select transactions relevant to the other company are sent (as determined by security rules). The security mechanism also filters out any sensitive data within the transaction (at the atomic instruction level) ensuring that it is this data is not even in the transaction sent. The transaction is then encrypted/decrypted using a public/private key so that the contents of the transaction cannot be viewed by intermediate servers on the internet. It is also possible for the asynchronous replication servers to send out noise transactions to make very difficult for external servers to determine which are valid transactions and which are just noise.

Five people using local version of the database management system on their laptops and need to work together. The share a common Dropbox folder. Transactions are encapsulated as files and Dropbox provides the vehicle to transfer the transactions. All five laptops are worked on locally and the transactions are asynchronously sync on all laptops working on the project.

A user is working offsite and has no connection to the central server. Work is done locally on their laptop which records the transactions over a period of time. Once the user is back online, the list of transactions performed can be sent to the central server and synchronized.

Two facilities are using the database management system to work together. However, the internet connection is poor and often goes down for hours at a time. The local device of the database management system queues up the transactions and they are not sent until the internet connection is back up again. At that point the local device can start sending transactions again. Because the transactions are re-run on the remote server as if they run at the original time, all data conflicts are resolved.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A server comprising:
a memory; and
a processor programmed to:
receive, from at least one client device, at least one transaction message including at least one transaction, the at least one transaction comprising:
an instruction; and
a transaction metadata, including at least one transaction timestamp;
generate an asynchronous transaction list comprising the at least one transaction;
receive a transaction time;
obtain an execution scheme;
order the asynchronous transaction list as an ordered transaction list as a function of the execution scheme and the transaction metadata; and
cause a transaction engine to execute the ordered transaction list.

2. The server of claim 1, wherein the instruction comprises an atomic instruction;

3. The server of claim 1, wherein the at least one transaction comprises a plurality of instructions.

4. The server of claim 1, wherein the execution scheme comprises a time scaling factor.

5. The server of claim 2, wherein the time scaling factor is linear.

6. The server of claim 2, wherein the time scaling factor is non-linear.

7. The server of claim 1, wherein the at least one transaction timestamp comprises one or more of:
a submission time indicating when the at least one transaction was submitted;
an acceptance time indicating when the at least one transaction was accepted; and
a commit time indicating when at least one transaction was committed.

8. The server of claim 1, the ordered transaction list is sorted based on a chronological order of member transactions within the asynchronous transaction list according to the at least one transaction timestamp.

9. The server of claim 1, wherein the transaction metadata further comprises a transaction priority value.

10. The server of claim 1, wherein the order execution list comprises a time shifted transaction list.

11. The server of claim 10, wherein the time shifted transaction list comprises at least one of the following: a time compressed list and a time expanded list.

12. The server of claim 1, wherein the processor is further programmed to report an execution result execution of the ordered transaction list.

13. The server of claim 1, wherein the processor is further programmed to:
detect a conflict during the execution of the ordered transaction; and
report the conflict to a user.

14. The server of claim 1, wherein the ordered transaction list is order according to at least one of the following categories of transaction metadata: geo-location, urgency, importance, conflict likelihood, risk, sensitivity, confidentiality, type of transaction data, type of instruction, context, transaction latency, transaction bandwidth, user identification, and group identification.

15. A transaction simulation server comprising:
a memory;
a processor programmed to:
receive, from at least one client device, at least one transaction message containing at least one transaction, the at least one transaction comprising:
an instruction;
a transaction metadata, including at least one transaction timestamp; and
generate a simulation timeframe as a function of a real-world time span, wherein the real-world time span includes a transaction time point indicated by the at least one transaction timestamp;
generate at least one simulation timestamp within the simulation timeframe, the at least one simulation timestamp corresponding to the transaction time point of the at least one transaction timestamp within the real-world time span;
map the at least one transaction to the at least one simulation timestamp; and
execute the at least one transaction according to the at least one simulation timestamp within the simulation timeframe.

16. The server of claim 15, wherein the at least one transaction comprises a plurality of instructions.

17. The server of claim 15, wherein the instruction comprises an atomic instruction.

18. The server of claim 15, wherein the simulation timeframe comprises an asynchronous simulation timeframe.

19. The server of claim 15, wherein the simulation timeframe comprises a synchronous simulation timeframe.

20. The server of claim 15, wherein the simulation timeframe comprises an isochronous simulation timeframe.

21. The server of claim 15, wherein the at least one transaction timestamp comprises one or more of:
a submission time indicating when the at least one transaction was submitted;
an acceptance time indicating when the at least one transaction was accepted; and
a commit time indicating when at least one transaction was committed.

22. The server of claim 15, wherein the processor is further programmed to report an execution result of execution of the at least one transaction.

23. The server of claim 15, wherein the processor is further programmed to:
detect a conflict relating to the execution of the at least one transaction; and
report the conflict to a user.

24. The server of claim 15, wherein the processor is further programmed to:
generate at least one secondary simulation timestamp within the simulation timeframe, the at least one secondary simulation timestamp corresponding to the a secondary transaction time point that is different from the transaction time point of the at least one transaction timestamp within the real-world time span;
map the at least one transaction to the at least one secondary simulation timestamp; and
execute the at least one transaction according to the at least one secondary simulation timestamp within the simulation timeframe.

25. The server of claim 24, wherein the processor further configured to generate the secondary simulation timestamp as a function of the transaction metadata, wherein the transaction metadata includes at least one of the following categories of metadata: a geo-location, urgency, importance, conflict likelihood, risk, sensitivity, confidentiality, type of transaction data, type of instruction, context, transaction latency, transaction bandwidth, user identification, and group identification.
